(19) United States
(12) Patent Application Publication
(10) Pub. No.: US 2004/0113798 A1
(43) Pub. Date: Jun. 17, 2004

(54) Sea rescue informing apparatus and life boat comprising the apparatus

(75) Inventors: Katsutoshi Takamura, Sakura-shi (JP); Katsumi Yamada, Sagamihara-shi (JP); Masao Hikita, Tokyo (JP)

Correspondence Address: JORDAN AND HAMBURG LLP, 122 EAST 42ND STREET, SUITE 4000, NEW YORK, NY, 10168, US

(73) Assignees: ELNA KABUSHIKI KAISHA, Yokohama-shi (JP); ELNA COMPONENTS KABUSHIKI KAISHA, Shinagawa-ku (JP)

(21) Appl. No.: 10/728,010

(22) Filed: Dec. 4, 2003

(30) Foreign Application Priority Data
Dec. 11, 2002 (JP) 2002-358817

(51) Int. Cl. G08B 23/00

(52) U.S. Cl. 340/573.6; 340/691.1

(57) ABSTRACT

It is an object of this invention to provide a sea rescue informing apparatus and a life boat comprising the sea rescue informing apparatus. The sea rescue informing apparatus can securely inform a rescuer about the current position of a sufferer by continuously operating a rescue informing device with no fear of electric power consumption.

According to FIG. 1, the sea rescue informing apparatus includes at least a rescue informing device 12 having an illuminator 13 and a rescue signal generator 17, and an electric power source 32 having a solar battery 33 and an electric charger 36 for supplying electricity to the rescue informing device 12. The rescue informing device 12 and the electric power source 32 are disposed in the sea rescue informing apparatus with light emission from the illuminator 13 and rescue signal transmission from the rescue signal generator 17 freely operated by electricity supplied from the electric charger 36 charged by electric power sent from the solar battery 33.

### FIELD OF THE INVENTION

The present invention relates to a sea rescue informing apparatus and a life boat including the sea rescue informing apparatus. When a sufferer evacuates and moves to the life boat in a sea accident, the sufferer can inform a rescuer sending a searching airplane and/or a rescue ship as to easily capture the current position of the sufferer by using the sea rescue informing apparatus.

### BACKGROUND OF THE INVENTION

In a sea accident, a sufferer should be rapidly rescued and the current position of a sufferer needs to be rapidly and accurately captured. As related arts, a lifesaving buoy informing the current position of a sufferer is suggested in Japanese Patent Application Publication No.2000-103391 (paragraph [0023] in page 3 and in FIG. 2) and a lifesaving light emission device easily finding a sufferer at night is also suggested in Japanese Patent Application Publication No.2002-269645 (paragraphs [0013] to [0014] in page 3 and in FIG. 2)

However, with regard to the lifesaving buoy in Japanese Patent Application Publication No.2000-103391, there lies a disadvantage as follows. Since a driving power source is charged from an external power source, even if, firstly, the buoy is fully charged, the electric power is wholly consumed as time passes and the rescue signal generator stops transmitting a rescue signal in a short time by applying no electric power to the rescue signal generator.

With regard to the lifesaving light emission device in Japanese Patent Application Publication No.2002-269645, there lies a disadvantage as follows. Since the lifesaving light emission device includes an electric double-layer capacitor charged by receiving supplied electricity from a solar battery, the lifesaving light emission device can turn on an LED (Light Emitting Diode) when necessary with no fear of electric power consumption. However, the device has no rescue signal generator and no rescue signal informing the current position of a sufferer can be transmitted.

### SUMMARY OF THE INVENTION

In consideration of the above-described disadvantages, it is, therefore, an object of this invention to provide a sea rescue informing apparatus and a life boat including the sea rescue informing apparatus, which can securely inform a rescuer about the current position of a sufferer by continuously emitting light and continuously transmitting a rescue signal with no fear of electric power consumption.

The present invention is directed for achieving the above-described object. The first aspect relates to the sea rescue informing apparatus, which includes at least a rescue informing device and an electric power source. The rescue informing device has a illuminator and a rescue signal generator, and the electric power source has a solar battery and an electric charger for supplying electricity to the rescue informing device. It is structurally characterized in that the rescue informing device and the electric power source are disposed in the sea rescue informing apparatus with light emission from the illuminator and rescue signal transmission from the rescue signal generator freely operated by electricity supplied from the electric charger charged by the electric power sent from the solar battery.

In this case, it is preferable that the rescue informing device and the electric power source are watertight-disposed in a hermetically sealed casing from which a photo acceptance panel surface of the solar battery and a communication antenna included in the rescue signal generator are exposed. It is preferable that the electric charger is formed with electric double-layer capacitors, which can be rapidly charged by the solar battery. Further, the rescue informing device can be so formed as to include a GPS positioning device.

On the other hand, the second aspect relates to a life boat. It is structurally characterized in that the life boat includes the sea rescue informing apparatus in a boat body of the life boat. In this case, a luminous face of the illuminator can be disposed on the top surface of the sea rescue informing apparatus, and a photo acceptance panel surface of the solar battery can be also disposed on a suitable surface area of the boat body where the sunlight can be received.

### BRIEF DESCRIPTION OF THE DRAWINGS

FIG. 1 is a blocked explanatory view showing a structural example of the first embodiment of the invention, which relates to a sea rescue informing apparatus.

FIG. 2 is an explanatory view showing an outline of one example of the second embodiment of the invention, which relates to a life boat.

### DETAILED DESCRIPTION OF THE PREFERRED EMBODIMENTS

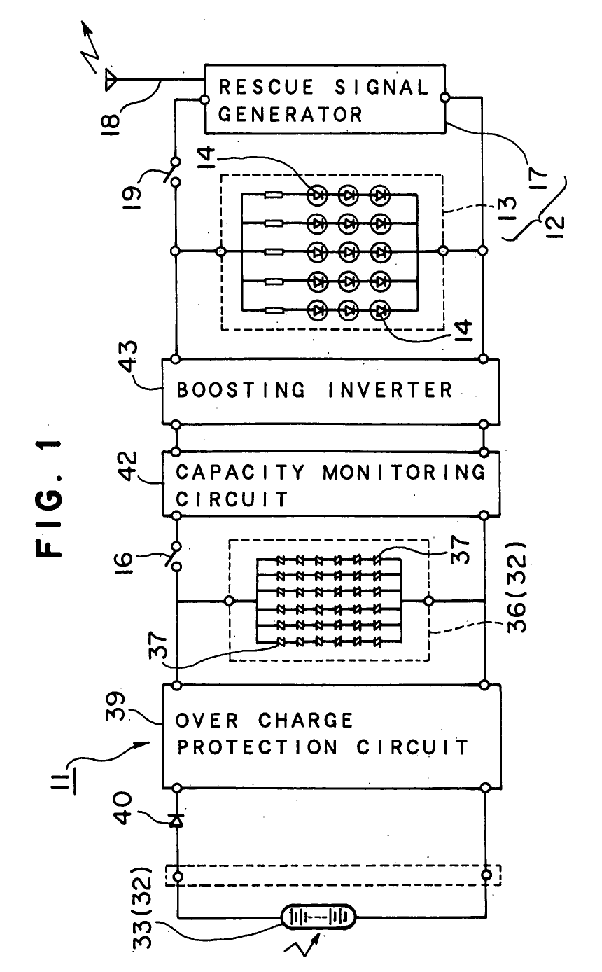

FIG. 1 is an explanatory view showing an outline of the first embodiment of this invention. A sea rescue informing apparatus 11 includes a sea rescue informing device 12 having an illuminator 13 emitting light and a rescue signal generator 17 transmitting a necessary signal. The sea rescue informing apparatus 11 also includes an electric power source 32 having a solar battery 33 and an electric charger 36 provided for supplying electricity to the rescue informing device 12.

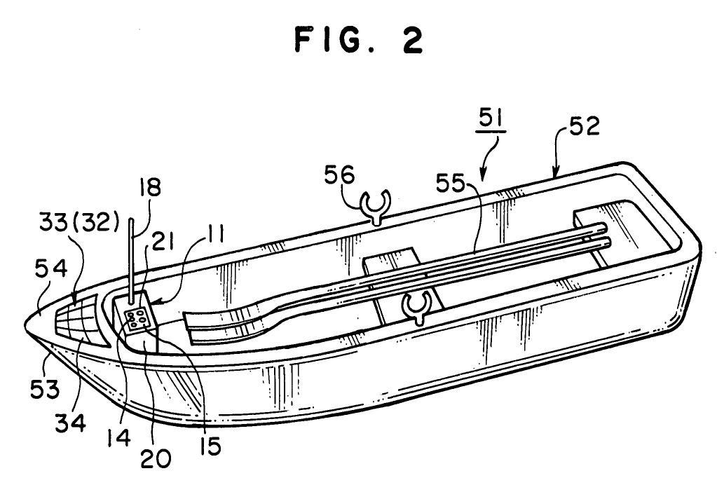

Further, for example, as shown in FIG. 2, the sea rescue informing apparatus 11 is disposed in a hermetically sealed casing 20 with a luminous face 15 of the illuminator 13 and a photo acceptance panel surface 34 of the solar battery 33 disposed on the outside of the casing, and a communication antenna 18 included in the rescue signal generator 17 protruded from the casing. The hermetically sealed casing 20 is suitably shaped and is made of watertight and corrosion-resistant material, such as stainless steel or synthetic resin.

The illuminator 13 structuring the rescue informing device 12 is preferably used with a plurality of LEDs (Light Emitting Diodes) 14 which emit orange light having high luminance, or the like. The light can be emitted to the outside of the illuminator 13 through the luminous face 15.

The rescue signal generator 17 can be used with one of various signal generating instruments, such as a wireless transmitter or a satellite cellular phone, continuously transmitting a rescue signal, such as SOS signal, from the antenna 18. In this case, a rescue signal transmitted from the rescue signal generator 17 can includes a position information obtained from a GPS positioning device which is not shown.

The solar battery 33 structuring the electric power source 32 is formed with a silicon solar battery or the like so designed as to obtain a required predetermined voltage. As shown in FIG. 2, the photo acceptance panel surface 34 of the solar battery is so disposed as to face to the direction where the panel can always receive the sunlight.

The electric charger 36 is formed with a plurality of electric double-layer capacitors 37, each of which has the rated performance of 100 F at 2.5 V. The capacitors can be charged by receiving electricity from the solar battery 33. A member of reference numeral 16 in FIG. 1 is a switch for halting electricity supplied to the rescue informing device 12 in non-operation.

Further, an overcharge protection circuit 39 is disposed between the solar battery 33 and the electric charger 36 so that each of the electric double-layer capacitors of the electric charger 36 is charged with the voltage of the each of the capacitors controlled. A member of reference numeral 40 in FIG. 1 is a back-flow preventing diode for preventing the current flowing from the electric charger 36 from back-flowing.

A capacity monitoring circuit 42 is disposed between the electric charger 36 and the illuminator 13 for turning on a check lamp (not shown) formed with an LED or the like when the electric double-layer capacitors of the electric charger 36 are fully charged or when the electric charge of the capacitors is insufficient. A boosting inverter 43 is also disposed between the electric charger 36 and the illuminator 13 for boosting a voltage applied to the rescue informing device 12 including the illuminator 13 and the rescuer signal generator 17.

Further, a switch 19 is disposed between the illuminator 13 structuring the rescue informing device 12 and the rescue signal generator 17 so that transmission of the rescue signal can be on-and-off-controlled by switching the switch 19 on-or-off.

The illuminator 13 can be so disposed as to blink each of the LEDs 14 at a predetermined time interval by a blinking control circuit which is not shown. For example, it can make the capacity of the electric double-layer capacitors smaller by decreasing power consumption that transmission of the rescue signal and/or light emission are turned on for one second of time and turned off for five seconds of time. With regard to the capacity of the electric double-layer capacitors 37, in consideration that cloudy or rainy days continue, the electric double-layer capacitors 37 having the capacity enough to continuously operate the sea rescue informing apparatus 11 during two or three days are preferably used. For example, the capacity of 500 F of the electric double-layer capacitors can operate the sea rescue informing apparatus 11 during approximate three days.

FIG. 2 shows the second embodiment of this invention. A life boat 51 includes at least a boat body 52 and the sea rescue informing apparatus 11. The boat body 52 is piloted by manually rowing with oars 55 locked in oarlocks 56 and the sea rescue informing apparatus 11 having structure above-described is mounted in the boat body 52. However, the boat body 52 is not limited to the example illustrated in FIG. 2. For example, an inflatable rubber boat, a yacht, a cruiser or one of various boats with an engine can be used as the boat body.

In this case, the sea rescue apparatus 11 is mounted in the boat body 52 with a luminous face 15 of the illuminator 13 disposed on the top surface 21 of the hermetically sealed casing 20. A photo acceptance panel surface 34 of the solar battery 33 is disposed on a suitable surface area where the sunlight can be received, such as a flat face 54 of a prow 53.

According to the sea rescue informing apparatus 11 of the first embodiment of this invention, the sea rescue informing apparatus 11 is loaded on the life boat in an emergency so that the illuminator 13 and the rescue signal generator 17 included in the rescue informing device 12 can securely inform a rescuer day and night about the current position.

Further, the rescue informing apparatus 11 includes the electric power source 32 having the solar battery 33 and the electric double-layer capacitors 37 of the electric charger 36. Since the rescue informing apparatus 11 can be electrically recharged even if the electric power is wholly consumed as time passes, light emission from the illuminator 13 and transmission of the rescue signal from the rescue signal generator 17 can continue without a halt. Further, since the electric double-layer capacitors 37 can be charged by a smaller electric current compared with a secondary battery, the capacitors 37 are preferably used even on cloudy days while the capacitors continue to be charged.

Therefore, since light emission and transmission of the rescue signal can continue with no fear of electric power consumption, the current position of a sufferer can be securely informed to a rescuer.

According to the second embodiment of this invention, which shows the life boat 51, the sea rescue informing apparatus 11 is mounted in the boat body 52 with the luminous face 15 of the illuminator 13 disposed on the top surface 21 of the hermetically sealed casing 20 and, further, the photo acceptance panel surface 34 of the solar battery 33 is disposed on the flat face 54 of the prow 53 where the sunlight can be received. So that the electric double-layer capacitors 37 can be charged while the photoelectric conversion is effectively carried out.

Even in an emergency, once a sufferer operates a predetermined simple operation after boarding on the life boat 51 having the boat body 52 in which the sea rescue informing apparatus 11 has been mounted, the sufferer can securely inform day and night a rescuer about the current position by using the illuminator 13 and the rescue signal generator 17.

As described above, according to the first embodiment of this invention, which shows the sea rescue informing apparatus, the sea rescue informing apparatus is loaded on the life boat and the rescue informing device can securely inform day and night a rescuer about the current position.

Further, since the sea rescue informing apparatus includes the electric power source, the sea rescue informing apparatus can continue to operate the rescue informing device by the recharging even if the electric power is wholly consumed as time passes.

According to the second embodiment of this invention, which shows the life boat, since the sea rescue informing apparatus, which is shown in the first embodiment, has been mounted in the boat body, the current position can be securely informed day and night to a rescuer by use of the rescue informing device with the simple predetermined operation after boarding on the life boat in an emergency.

1. A sea rescue informing apparatus comprising at least a rescue informing device and an electric power source, the rescue informing device having an illuminator and a rescue signal generator, the electric power source having a solar battery and an electric charger for supplying electricity to the rescue informing device, wherein the rescue informing device and the electric power source are disposed in the sea rescue informing apparatus with light emission from the illuminator and rescue signal transmission from the rescue signal generator freely operated by electricity supplied from the electric charger, the electric charger charged by electric power sent from the solar battery.

2. A sea rescue informing apparatus according to claim 1, wherein the rescue informing device and the electric power source are disposed in a watertight hermetically sealed casing with a photo acceptance panel surface of the solar battery and a communication antenna included in the rescue signal generator exposed from the watertight hermetically sealed casing.

3. A sea rescue informing apparatus according to claim 1, wherein the electric charger comprises one or more electric double-layer capacitors rapidly chargeable from the solar battery.

4. A sea rescue informing apparatus according to claim 1, wherein a rescue signal transmitted from the rescue signal generator includes position information obtained from a GPS positioning device.

5. A life boat comprising a boat body and a sea rescue informing apparatus, the sea rescue informing apparatus being the sea rescue informing apparatus according to any one of claims 1 to 4, the sea rescue informing apparatus mounted in the boat body.

6. A life boat according to claim 5, wherein a luminous face of the illuminator is disposed on the top surface of the sea rescue informing apparatus, and a photo acceptance panel surface of the solar battery is disposed on a suitable surface area of the boat body where the sunlight is able to be received.
